(19) United States
(12) Patent Application Publication
(10) Pub. No.: US 2024/0307833 A1
(43) Pub. Date: Sep. 19, 2024

(54) ULTRA FINE BUBBLE PRODUCTION APPARATUS AND PRODUCTION METHOD

(71) Applicant: CANON KABUSHIKI KAISHA, Tokyo (JP)

(72) Inventors: RUI SEKINE, Kanagawa (JP); AKIRA YAMAMOTO, Kanagawa (JP)

(21) Appl. No.: 18/602,764

(22) Filed: Mar. 12, 2024

(30) Foreign Application Priority Data
Mar. 14, 2023 (JP) 2023-039740
Dec. 12, 2023 (JP) 2023-209478

(51) Int. Cl. B01F 23/231; B01F 35/21; B01F 35/213; B01F 35/221; B01F 35/71; B01F 35/90

(52) U.S. Cl. CPC B01F 23/23105; B01F 35/2115; B01F 35/213; B01F 35/2215; B01F 35/712; B01F 2035/98

(57) ABSTRACT

Provided are an ultra fine bubble production apparatus and production method capable of collecting ultra fine bubbles efficiently. To this end, a cooler unit is controlled so that a temperature of a liquid in a collector unit can be lower than a temperature of a liquid containing ultra fine bubbles generated in an ultra fine bubble generation unit.

### BACKGROUND

### Field

The present disclosure generally relates to an ultra fine bubble production apparatus and production method.

### Description of the Related Art

In recent years, technologies have been developed which apply the characteristics of fine bubbles such as microbubbles with a diameter of micrometers and nanobubbles with a diameter of nanometers. The usefulness of ultra fine bubbles with a diameter of less than 1.0 μm (hereinafter also abbreviated as “UFB”), in particular, has been confirmed in various fields, where um corresponds to micrometer.

Japanese Patent Laid-Open No. 2015-181976 discloses an apparatus in which a pressure-dissolving unit configured to dissolve a desired gas into a liquid under pressure and a fine bubble generation unit configured to generate fine bubbles by injecting the liquid from a fine nozzle are installed in the same liquid circulation channel, and which generates fine bubbles at a high concentration.

In addition, Japanese Patent Laid-Open No. 2019-42732 discloses that a heating element is applied to a fine bubble generation unit and is operated to generate heat in a liquid to cause film boiling, and describes a method of causing film boiling and ejecting superfine droplets to generate superfine UFB with small variations in particle size (thermal-ultra fine bubble: hereinafter also abbreviated as “T-UFB”).

However, in some cases where the fine bubbles are collected in the method in Japanese Patent Laid-Open Nos. 2015-181976 and 2019-42732, the fine bubble-containing water generated in the fine bubble generation unit may have a liquid temperature raised as compared with the liquid fed to the fine bubble generation unit because excess heat from the generation of fine bubbles is transferred to the liquid.

Under the condition where the liquids in the apparatus are under a certain pressure such as atmospheric pressure, the gas dissolved in the fine bubble-containing water vaporizes along with a rise in the liquid temperature, which creates a state where bubbles are likely to be generated. As a result, relatively large bubbles thus generated may cause coalescence of generated fine bubbles and therefore act as an impediment factor for the generation of the fine bubbles. Consequently, there is a possibility of decreasing the number concentration of UFB that can be collected.

### SUMMARY

Therefore, the present disclosure provides an ultra fine bubble production apparatus and production method capable of collecting ultra fine bubbles efficiently.

To achieve this, some embodiments of an ultra fine bubble production apparatus in the present disclosure include: an ultra fine bubble generator configured to generate ultra fine bubbles; a collector configured to collect a liquid containing the ultra fine bubbles generated in the ultra fine bubble generator; a first cooler capable of cooling a liquid in the collector; and a controller configured to control the first cooler, wherein the controller controls the first cooler so that a temperature of the liquid in the collector is lower than a temperature of the liquid containing the ultra fine bubbles generated in the ultra fine bubble generator.

According to the present disclosure, it is possible to provide an ultra fine bubble production apparatus and production method capable of collecting ultra fine bubbles efficiently.

Further features of the present disclosure will become apparent from the following description of exemplary embodiments with reference to the attached drawings.

### BRIEF DESCRIPTION OF THE DRAWINGS

FIG. 1 is a schematic structural diagram illustrating an ultra fine bubble (UFB) generation apparatus.

FIG. 2 is a block diagram illustrating a control configuration of the UFB generation apparatus of FIG. 1.

FIG. 3A is a flowchart presenting UFB generation processing.

FIG. 3B is a flowchart presenting a subroutine in the flowchart of FIG. 3A.

FIG. 3C is a flowchart presenting a subroutine in the flowchart of FIG. 3A.

FIGS. 4, 5, and 6 are schematic structural diagrams illustrating UFB generation apparatuses according to some embodiments.

FIG. 7A is a flowchart presenting UFB generation processing.

FIG. 7B is a flowchart presenting a subroutine in the flowchart of FIG. 7A.

### DESCRIPTION OF THE EMBODIMENTS

Various exemplary embodiments, features, and aspects of the disclosure will be described in detail below with reference to the drawings.

### First Embodiment

Hereinafter, a first embodiment of the present disclosure will be described with reference to the drawings.

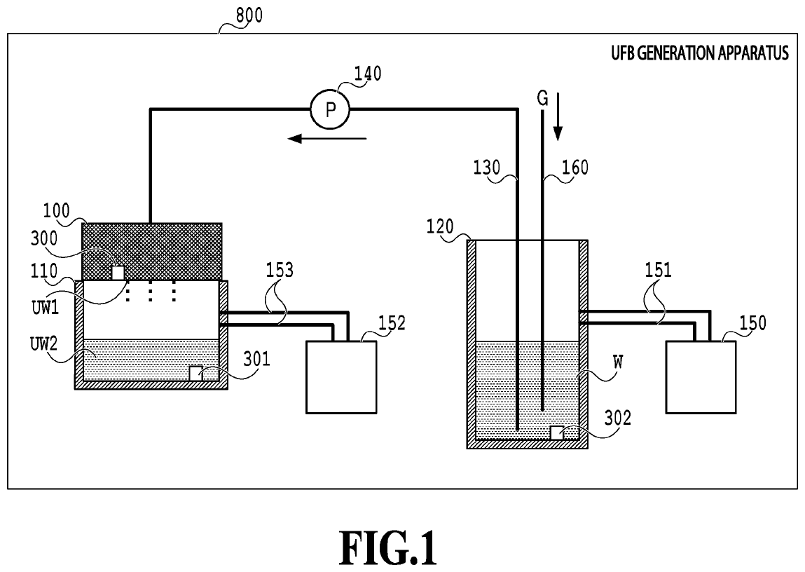

FIG. 1 is a schematic structural diagram illustrating an ultra fine bubble generation apparatus (hereinafter also abbreviated as the UFB generation apparatus) 800 to which the present embodiment is applicable. The UFB generation apparatus 800 includes a liquid feeder unit 120, an ultra fine bubble generator unit (hereinafter abbreviated as the UFB generator unit) 100, a collector unit 110, and cooler units 150 and 152.

The feeder unit 120 includes a liquid feeding tube 130, a gas inlet tube 160, and a liquid temperature sensor 302. A liquid W stored in the liquid feeder unit 120 is fed to the UFB generator unit 100 by a pump 140 through the liquid feeding tube 130. In the liquid W stored in the feeder unit 120, any desired gas G can be dissolved by being introduced through the gas inlet tube 160.

The temperature of the liquid W is desirably low in order to efficiently dissolve the gas G in the liquid W. To this end, the feeder unit 120 is equipped with the cooler unit 150 and the liquid W is cooled by using the cooler unit 150. A structure of the cooler unit 150 may employ a method such as, but not particularly limited to, a method using a Peltier element or a method of circulating a liquid cooled by a chiller. In the latter case, a cooling tube 151 may be wound around an outer circumference of the feeder unit 120. Instead, the feeder unit 120 may be formed with a hollow structure and a cooling tube may be placed in the hollow space. Alternatively, the cooling tube 151 may be immersed in the liquid W in the feeder unit 120.

In the present embodiment, the temperature of the liquid W is regulated at about 10° C. by using the cooler unit 150 while the temperature of the liquid W is being detected by the liquid temperature sensor 302. With the temperature of the liquid W regulated at about 10° C., the gas G can be efficiency dissolved in the liquid W.

The UFB generator unit 100 generates UFB in the liquid W poured therein. As a method of generating ultra fine bubbles (hereinafter also abbreviated as UFB), the present embodiment employs a T-UFB method of generating ultra fine bubbles by generating heat from a heating element and thereby causing film boiling at an interface between the liquid and the heating element. Instead, the method may be a UFB generation method of extracting a dissolved gas by reducing the pressure of the liquid using the Venturi effect. In any case, the problem of the present disclosure associated with the vaporization of a dissolved gas may occur as long as there is a possibility that the temperature of the liquid is raised by the excess heat generated in the UFB generation mechanism or that the temperature of the liquid naturally rises in the flow channel leading to the UFB generator unit.

In the present embodiment, a temperature sensor (thermometer) 300 detects the temperature of the UFB generator unit 100, and thereby detects the temperature of a UFB-containing liquid UW1 in the UFB generator unit 100. Here, the temperature sensor 300 may be installed inside a flow channel in the UFB generator unit 100 and configured to directly measure the liquid temperature, or may be installed outside the flow channel in the UFB generator unit 100 and configured to indirectly measure the liquid temperature. In addition, the UFB-containing liquid UW1 means a liquid immediately after generation of UFB in the UFB generator unit 100 and the temperature of the UFB-containing liquid UW1 is equivalent to the temperature of the liquid in the UFB generator unit and immediately after exit from the UFB generator unit 100 (for example, droplets immediately after ejection).

The collector unit 110 collects the UFB-containing liquid UW1 generated in the UFB generator unit 100. The UFB-containing liquid flowing into and stored in the collector unit 110 is redefined as a UFB-containing liquid UW2. The collector unit 110 includes a liquid temperature sensor 301 capable of obtaining the temperature of the liquid stored in the collector unit 110, and the liquid temperature sensor 301 detects a temperature T2 of the UFB-containing liquid UW2 flowing into and stored in the collector unit 110. The collector unit 110 may be a container capable of storing a certain amount of liquid as illustrated in FIG. 1 or may have a flow channel structure through which the liquid flows.

The cooler unit 152 is coupled to the collector unit 110 and cools the UFB-containing liquid UW2 in the collector unit 110. The UFB-containing liquid UW1 generated in the UFB generator unit 100 raises in liquid temperature as compared with the liquid W in the liquid feeder unit 120 due to excess heat generated in the UFB generator unit 100 and a natural temperature rise through the flow channel to the UFB generator unit 100. As the liquid temperature rises, the gas solubility in the liquid decreases. As a result, the gas in the liquid vaporizes to cause bubble coalescence or the like of UFB in the UFB-containing liquid UW2, and thereby may act as an impediment factor for efficient UFB collection. To address this, the cooler unit 152 cools the UFB-containing liquid UW2, so that the decrease in the gas solubility in the liquid can be suppressed and the efficient UFB collection can be achieved.

A structure of the cooler unit 152 may employ a method such as, but not particularly limited to, a method using a Peltier element or a method of circulating a liquid cooled by a chiller. In the latter case, a cooling tube 153 may be wound around an outer circumference of the collector unit 110. Instead, the liquid feeder unit 120 may be formed with a hollow structure and a cooling tube may be placed in the hollow space. Alternatively, the cooling tube may be immersed in the UFB-containing liquid UW2 in the collector unit 110. The cooler unit 152 and the cooler unit 150 may be integrated into a single cooling apparatus capable of cooling both the collector unit 110 and the feeder unit 120.

In the present embodiment, the cooler unit 152 is controlled so that the temperature T2 of the UFB-containing liquid UW2 in the collector unit 110 may be regulated within a predetermined range. The specific method will be described below.

A liquid temperature rise due to the heat generation in the UFB generator unit 100, the environmental temperature, and the like facilitates vaporization of the dissolved gas in the UFB-containing water, and relatively large bubbles generated by the vaporization cause coalescence of generated UFB and thereby may act as an impediment factor for efficient collection of generated UFB.

To avoid this, in the present embodiment, the cooler unit 152 is controlled based on the detection values obtained by the respective temperature sensors under a constant pressure in the UFB generation apparatus 800. Specifically, the cooler unit 152 is controlled in reference to a temperature T3 of the liquid W detected by the liquid temperature sensor 302, a temperature T1 of the UFB-containing liquid UW1 detected by the temperature sensor 300, and the temperature T2 of the UFB-containing liquid UW2 detected by the liquid temperature sensor 301. More specifically, the driving of the cooler unit 152 is controlled so that the temperature T2 of the UFB-containing liquid UW2 in the collector unit 110 may be regulated within a range defined as T2<T1 and also T2<T3+5° C. (T2 is lower than a temperature higher than T3 by 5° C.). Meanwhile, the cooler unit 150 cools the liquid W in the feeder unit 120 without dynamic control.

In order to suppress a decrease in the gas solubility of the UFB-containing liquid UW2 in the collector unit 110, it is useful to avoid a temperature rise of the UFB-containing liquid UW2 due to the heat generation in the UFB generator unit 100. If the temperature T1 of the UFB-containing liquid UW1 and the temperature T2 of the UFB-containing liquid UW2 satisfy the condition T2<T1, it is possible to avoid a temperature rise of the UFB-containing liquid UW2 due to the heat generation in the UFB generator unit 100 and thereby suppress a decrease in the gas solubility.

Furthermore, if the temperature rise of the UFB-containing liquid UW2 from the temperature of the liquid W is equal to or less than 5° C., the decrease in the gas solubility can be further suppressed. For example, even under a low temperature (about 10° C.) at which the gas solubility greatly changes, in a case where only oxygen is dissolved in the liquid W, a change in the oxygen solubility with a temperature rise of 5° C. or less can be kept within about 8 mg/L, where mg corresponds to milligram and L corresponds to liter. Then, in a case where only carbon dioxide is dissolved in the liquid W, a change in the carbon dioxide solubility with a temperature rise of 5° C. or less can kept within about 50 mg/L, so that the vaporization in the UFB-containing liquid UW2 can be suppressed.

If both the conditions T2<T1 and T2<T3+5° C. are satisfied, the temperature sensor 300 and the liquid temperature sensors 301 and 302 do not have to be used and the cooler unit 152 may be operated without dynamic control. Moreover, in the present embodiment, the feeder unit 120 for use to introduce the gas G is not an essential element, and the UFB generation apparatus 800 may be only an apparatus that generates UFB of a gas contained in advance in the liquid W. In this case, if the condition T2<T1 is satisfied, the condition T2<T3+5° C. is not particularly needed.

The present embodiment is described for the case where the temperature sensor 300 and the liquid temperature sensors 301 and 302 are installed and the cooler unit 152 is controlled based on their detected temperatures. However, an embodiment is not limited to this. Since the gas solubility of a gas increases as the temperature of a liquid decreases, the collector unit 110 may be equipped with a gas solubility meter (solubility detector) and the cooler unit 152 may be controlled so that a change in each gas solubility depending on a gas type can be kept within 50 mg/L. This is because, if the change in the gas solubility is controlled to be kept within 50 mg/L, the relationship T2<T1 is satisfied in general and therefore the vaporization in the UFB-containing liquid UW2 can be suppressed.

The position and number of pumps 140 are not limited to those illustrated in FIG. 1. Moreover, each unit may internally include a pump and a valve to drive the unit. It should be noted that, as the pump, it is preferable to use a pump with small variations in pulsation and flow rate so as not to impair UFB generation efficiency.

The members to come into contact with the UFB-containing liquid like the feeder unit 120, the liquid feeding tube 130, the gas inlet tube 160, the pump 140, the collector unit 110, and the UFB generator unit 100 are preferably formed of highly corrosion-resistant materials. For example, fluororesins such as polytetrafluoroethylene (PTFE) and perfluoroalkoxyalkane (PFA), metals such as SUS316L, and other inorganic materials are suitably usable. Thus, even if a highly-corrosive gas G and/or liquid W are used, it is possible to generate UFB suitably.

Moreover, the liquid temperature sensors 301 and 302 and the temperature sensor 300 may be of any types. The temperature sensor may be a sensor using a thermocouple, a radiation thermometer, a pressure thermometer, or the like.

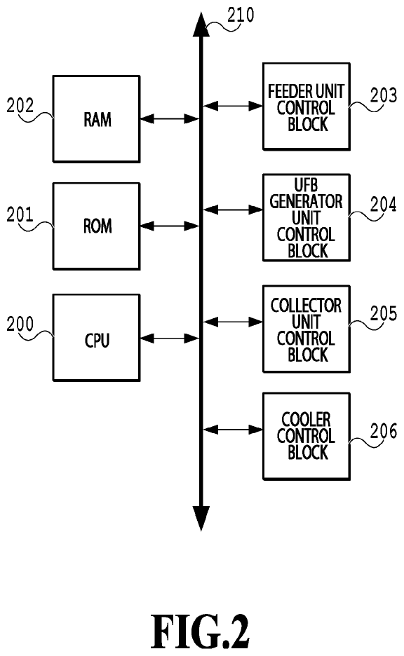

FIG. 2 is a block diagram illustrating a control configuration of the UFB generation apparatus 800, and may be referred to as a controller. A central processing unit (CPU) 200 controls the entire apparatus via a main bus 210 by using a random-access memory (RAM) 202 as a work area in accordance with a program stored in a read only memory (ROM) 201. The CPU 200 may include one or more processors, circuitry, or combinations thereof. A feeder unit control block 203 controls the pump 140, the gas inlet tube 160, the cooler unit 150, and the liquid temperature sensor 302 according to instructions from the CPU 200. A UFB generator unit control block 204 controls the UFB generator unit 100 and the temperature sensor 300 according to instructions from the CPU 200. A collector unit control block 205 controls the cooler unit 152 and the liquid temperature sensor 301 according to instructions from the CPU 200.

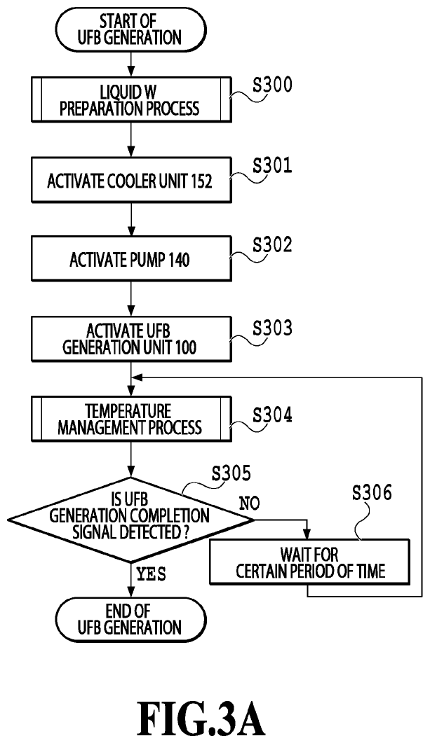

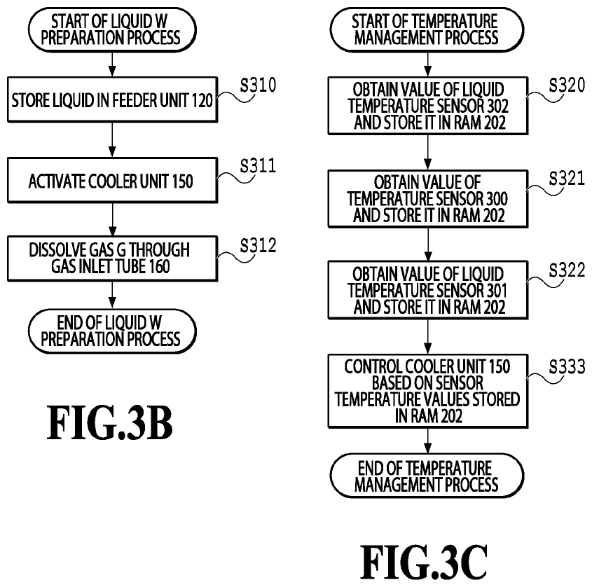

The block diagram in FIG. 2 is just one example, and the control block group is not particularly limited as long as it is capable of executing the steps of generating UFB in the present embodiment as will be described later by using FIGS. 3A to 3C.

FIG. 3A is a flowchart presenting UFB generation processing in the UFB generation apparatus 800. FIG. 3B is a flowchart presenting a subroutine in the flowchart of FIG. 3A and details of S300 for liquid W preparation. FIG. 3C is a flowchart presenting a subroutine in the flowchart of FIG. 3A and details of S304 for temperature management. The UFB generation processing in the UFB generation apparatus 800 will be described below by using the flowcharts in FIGS. 3A to 3C. A series of processes presented in FIGS. 3A to 3C is performed by the CPU 200 in the UFB generation apparatus 800 loading program codes stored in the ROM 201 into the RAM 202 and executing the loaded program codes. Instead, part or all of the functions in the steps included in FIGS. 3A to 3C may be implemented by hardware such as an ASIC or an electronic circuit. Here, sign “S” in description of each process indicates a step in the flowchart.

Upon the start of the UFB generation processing, a liquid W preparation process for feeding to the UFB generator unit 100 is started at S300. The details of the process at S300 will be described later. At S301, the cooler unit 152 is activated and made ready to cool the liquid in the collector unit 110. At S302, the pump 140 is activated and starts to feed the liquid W from the feeder unit 120 to the UFB generator unit 100. Then, at S303, the UFB generator unit 100 is activated and starts to generate UFB. After that, at S304, a temperature management process is performed. The details of the process at S304 will be described later.

At the end of the temperature management process, whether or not a UFB generation completion signal is detected is determined at S305. If the signal is not detected (No), the processing shifts to S306, waits for a certain period of time, returns to S304, and iterates the processes at S306, S304, and S305 until the signal is detected. During the iterations, the units activated at S300 to S303 are continuously operating. If the UFB generation completion signal is detected (Yes) at S305, the operations in the units are stopped as appropriate and the UFB generation processing is ended.

A method of generating the UFB generation completion signal detected at S305 is not particularly limited. For example, the signal may be an interrupt signal that is generated upon the completion of delivery of a certain amount of the liquid W, an interrupt signal that is generated upon the lapse of a certain period of time, an interrupt signal that is generated from a user interface (UI) unit operable by a user, or the like. In the UFB generation processing, the processing order in the sequence may be changed, if possible, such as an interchange in the processing order between S301 and S302.

Next, with reference to FIG. 3B, the details of the process at S300 in FIG. 3A (liquid W preparation process) will be described.

Upon the start of the liquid W preparation process, a liquid is stored in the feeder unit 120 at S310. After that, at S311, the cooler unit 150 is activated and starts to cool the liquid stored in the feeder unit 120. At S312, the gas G is fed to the liquid stored in the feeder unit 120 through the gas inlet tube 160 and is dissolved in the liquid, and then the liquid W preparation process is ended.

Next, with reference to FIG. 3C, the details of the process at S304 in FIG. 3A (temperature management process) will be described.

Upon the start of the temperature management process, at S320, the value of the temperature T3 of the liquid W is obtained from the liquid temperature sensor 302 and the obtained value is stored in the RAM 202. After that, at S321, the value of the temperature T1 of the UFB-containing liquid UW1 is obtained from the temperature sensor 300 and the obtained value is stored in the RAM 202. Subsequently, at S322, the value of the temperature T2 of the UFB-containing liquid UW2 is obtained from the liquid temperature sensor 301 and the obtained value is stored in the RAM 202.

Then, at S323, the control on the cooler unit 152 such as ON/OFF control and a change of the set temperature is performed based on the temperature values of these sensors stored in the RAM 202. Specifically, the cooler unit 152 is controlled so that the conditions T2<T1 and T2<T3+5° C. can be satisfied, and the temperature management process is ended.

Here, regarding the temperature of the feeder unit 120, the temperature of the liquid W is regulated at about 10° C. by cooling with the cooler unit 150, so that the temperature T3 is not changed greatly. The present embodiment is described for the case where each of the temperature sensors detects the temperature multiple times at S304 during the iterations of the processes at S306 to S305. However, the value of the temperature T3 to be detected by the liquid temperature sensor 302 may be detected only once and the detected value may be used. Specifically, the values of the temperatures T1 and T2 are obtained iteratively, while the value of the temperature T3 is obtained only once at the beginning. Then, the cooler unit 152 may be controlled so that the obtained temperatures T1, T2, and T3 can satisfy both the conditions T2<T1 and T2<T3+5° C.

As described above, the cooler unit 152 is controlled so that the temperature of the liquid in the collector unit 110 can be lower than the temperature of the liquid containing ultra fine bubbles generated by the ultra fine bubble generation unit 100. As a result, it is possible to provide an ultra fine bubble production apparatus and production method capable of collecting ultra fine bubbles efficiently.

In the present embodiment, 200 ml of pure water was stored in the feeder unit 120, and the cooler unit 150 was operated to regulate the temperature T3 of the pure water W in the feeder unit 120 at 10° C. Oxygen was introduced through the gas inlet tube 160 to produce supersaturated oxygen water (the concentration of dissolved oxygen: 20 mg/L or more). Then, while the cooler unit 152 was being operated, the UFB generator unit 100 was operated with feeding of the supersaturated oxygen water at 10 mL/min by using the pump 140. In this operation, the temperature T1 of the UFB-containing liquid UW1 in the UFB generator unit 100 was regulated within the maximum temperature of 38° C. and the temperature T2 of the UFB-containing liquid UW2 in the collector unit 110 was regulated within the maximum temperature of 19° C. As a result, the final number concentration of UFB in the UFB-containing liquid UW2 was 120 million/mL.

On the other hand, in the case where the temperature T2 of the UFB-containing liquid UW2 in the collector unit 110 reached the maximum temperature of 35° C. without operation of the cooler unit 152, the final number concentration of UFB in the UFB-containing liquid UW2 was less than 100 million/mL (about 80 million/mL).

Each of the number concentrations was measured 24 hours after the generation of the UFB-containing liquid by using a measurement instrument (model type SALD (registered trademark)-7500 nano) manufactured by Shimadzu Corporation.

From these results, the present embodiment can be said to produce a certain effect of improving the collection efficiency of highly-concentrated ultra fine bubbles.

### Second Embodiment

Hereinafter, a second embodiment of the present disclosure will be described with reference to the drawings. Since the basic structure of the present embodiment is the same as in the first embodiment, a characteristic structure will be described below. In the present embodiment, description will be given of a structure which includes a common unit to function as both the feeder unit and the collector unit described in the first embodiment and which is capable of feeding the generated UFB-containing liquid to the UFB generator unit by circulating the liquid.

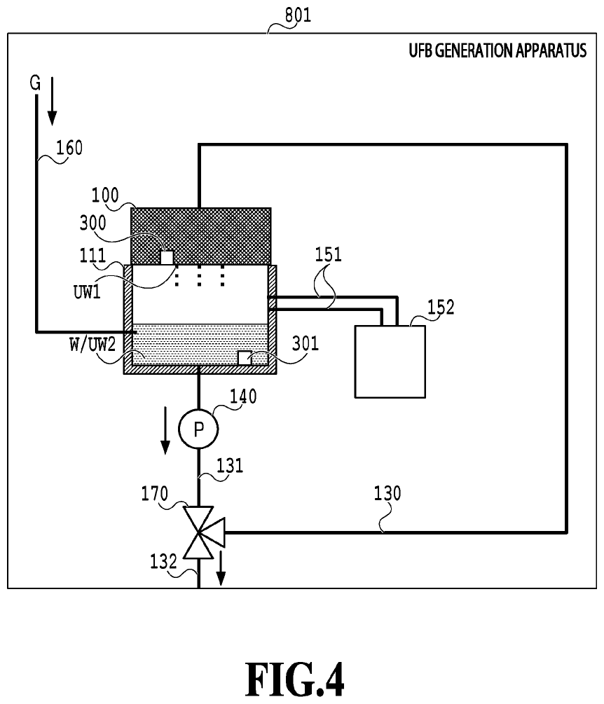

FIG. 4 is a schematic structural diagram illustrating a UFB generation apparatus 801 in the present embodiment. The UFB generation apparatus 801 mainly includes a feeder-collector unit 111, a UFB generator unit 100, and a cooler unit 152. The UFB generation apparatus 801 is configured to circulate a liquid between the feeder-collector unit 111 and the UFB generator unit 100, and circulates the liquid between the feeder-collector unit 111 and the UFB generator unit 100 by using liquid feeding tubes 131 and 130.

The feeder-collector unit 111 stores the liquid W and collects the UFB-containing liquid UW1 generated in the UFB generator unit 100. In the present embodiment, the gas G is fed to the liquid W stored in the feeder-collector unit 111 through a gas inlet tube 160, and the gas G is thus dissolved in the liquid W. The UFB generator unit 100 generates UFB while the liquid W as the feeding liquid and the UFB-containing liquid UW2 as the collected liquid are circulated by using the liquid feeding tubes 131 and 130, so that a highly-concentrated UFB-containing liquid UW2 can be finally produced.

In the present embodiment, the cooler unit 152 is controlled in reference to the temperature T1 of the UFB-containing liquid UW1 detected by the temperature sensor 300 and the temperature T2 of the UFB-containing liquid UW2 detected by the liquid temperature sensor 301. Specifically, the driving of the cooler unit 152 is controlled so that the temperature T2 of the UFB-containing liquid UW2 in the feeder-collector unit 111 can satisfy both the conditions T2<T1 and T2<T3+5° C. Here, the temperature T3 of the liquid W detected by the liquid temperature sensor 301 means the temperature of the liquid W that does not contain any UFB-containing liquid UW2 before the start of circulation. In this way, while the cooler unit 152 is being controlled, the liquid is circulated between the feeder-collector unit 111 and the UFB generator unit 100 and thereby the highly-concentrated UFB-containing liquid UW2 is produced.

After the completion of production of the desired UFB-containing liquid UW2, a three-way valve 170 is controlled to allow a flow in a direction from a liquid feeding tube 131 to a liquid collection tube 132. Thus, the highly-concentrated UFB-containing liquid UW2 can be taken out from the feeder-collector unit 111.

### Modification

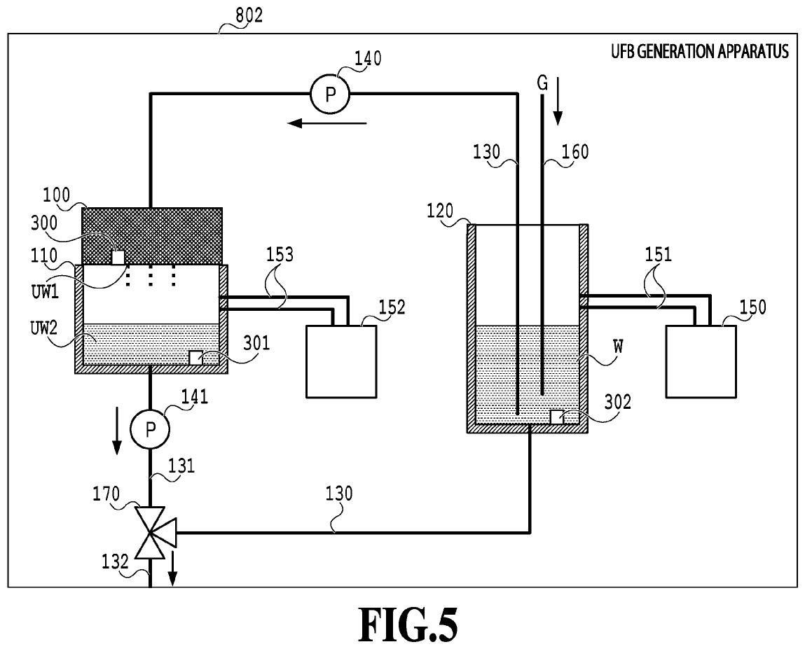

FIG. 5 is a schematic structural diagram illustrating a UFB generation apparatus 802 in a modification of the second embodiment. As in the UFB generation apparatus 802, a structure may be such that a feeder unit 120 and a collector unit 110 are separated and that the liquid is circulated among the feeder unit 120, the UFB generator unit 100, and the collector unit 110. For example, even if a desired gas is dissolved up to about a saturated solubility limit in the feeder unit 120, the gas component dissolved is transformed into UFB by the ultra fine bubble generation unit 100, and therefore the concentration of the desired gas dissolved in the liquid sent to the feeder unit 120 next is lower than the saturated solubility. For this reason, the same gas can be dissolved again up to about the saturated solubility. In other words, a structure as in FIG. 5 makes it possible to efficiently increase the concentration of UFB contained in the UFB-containing liquid UW2 by repeating dissolution of the gas up to about the saturated solubility and generation of UFB in the circulated liquid.

As described above, the apparatus is configured such that the liquid can be circulated between the collector unit 110 and the ultra fine bubble generation unit 100. Then, the cooler unit 152 is controlled so that the temperature of the liquid in the collector unit 110 can be lower than the temperature of the liquid containing ultra fine bubbles generated in the ultra fine bubble generation unit 100. Accordingly, it is possible to provide an ultra fine bubble production apparatus and production method capable of collecting ultra fine bubbles efficiently.

### Third Embodiment

Hereinafter, a third embodiment of the present disclosure will be described with reference to the drawings. Since the basic structure of the present embodiment is the same as in the first embodiment, a characteristic structure will be described below. In the present embodiment, part of the liquid in the feeder unit is sent to the collector unit 110 without passing through the UFB generator unit, thereby suppressing a temperature rise of the collector unit 110. In addition, the generated UFB-containing liquid is fed (circulated) from the collector unit 110 to the feeder unit 120 and then is sent to the UFB generator unit.

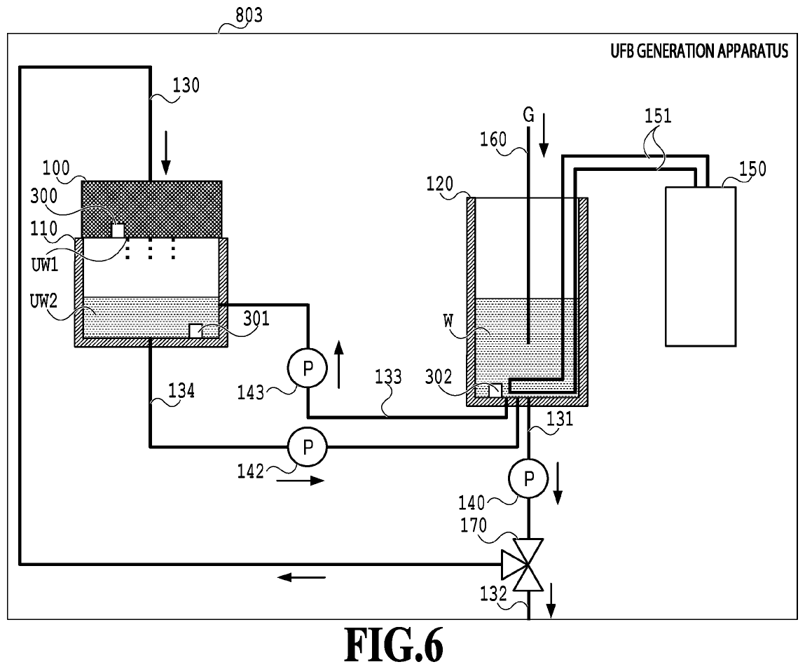

FIG. 6 is a schematic structural diagram illustrating a UFB generation apparatus 803 in the present embodiment. The UFB generation apparatus 803 in the present embodiment mainly includes a feeder unit 120, a UFB generator unit 100, a collector unit 110, and a cooler unit 150. Note that the UFB generation apparatus 803 does not include a cooler unit for the collector unit 110. In other words, the feeder unit 120, the UFB generator unit 100, and the collector unit 110 are cooled by controlling the cooler unit 150 and pumps 140, 142, and 143.

A liquid W stored in the feeder unit 120 is cooled by the cooler unit 150 through a cooling tube 151. The cooled liquid W can be sent to three channels by controlling a three-way valve 170 and the pumps 140 and 143. First, the liquid W can be sent by the pump 140 to the UFB generator unit 100 through a liquid feeding tube 130. Meanwhile, the liquid W can be sent by the pump 143 to the collector unit 110 through a liquid feeding tube 133. Further, the liquid W can be discharged by the pump 140 from the UFB generation apparatus 803 through a liquid collection tube 132. Thus, the feeder unit 120 has a system capable of sending the liquid W to the collector unit 110 without passing through the UFB generator unit 100. The liquid W thus sent without passing through the UFB generator unit 100 can be used to cool the UFB-containing liquid UW2 raised in temperature after passing through the UFB generator unit 100. The liquid UW2 stored in the collector unit 110 is fed (circulated) by the pump 142 to the feeder unit 120 through a liquid feeding tube 134.

In order to efficiently execute the cooling, it is preferable that the flow rate of the pump 143 be higher than the flow rate of the pump 140. However, the flow rate ratio may be any as long as the relationships between the temperature T3 of the liquid W, the temperature T1 of the UFB-containing liquid UW1, and the temperature T2 of the UFB-containing liquid UW2 satisfy T2<T1 and T2<T3+5° C.

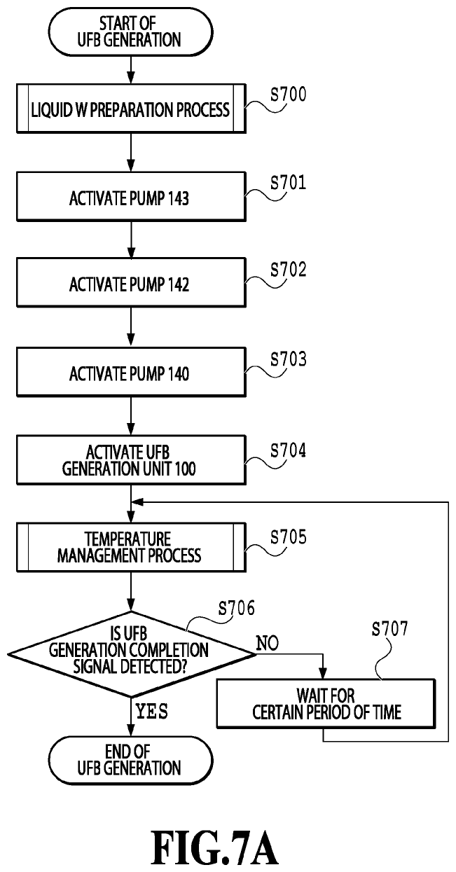

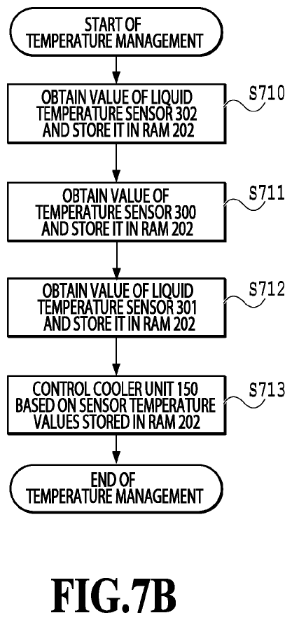

FIG. 7A is a flowchart presenting UFB generation processing in the UFB generation apparatus 803. FIG. 7B is a flowchart presenting a subroutine in the flowchart of FIG. 7A and details of S705 for temperature management. Hereinafter, the UFB generation processing in the UFB generation apparatus 803 will be described by using the flowcharts in FIGS. 7A and 7B. A series of processes presented in FIGS. 7A and 7B is performed by the CPU 200 in the UFB generation apparatus 803 loading program codes stored in the ROM 201 into the RAM 202 and executing the loaded program codes. Instead, part or all of the functions in the steps included in FIGS. 7A and 7B may be implemented by hardware such as an ASIC or an electronic circuit. Here, sign “S” in description of each process indicates a step in the flowchart.

Upon the start of the UFB generation processing, a liquid W preparation process for feeding to the UFB generator unit 100 is started at S700. The process at S700 is the same as the liquid W preparation process described in reference to FIG. 3B. Then, at S701, the pump 143 is activated and starts to feed the liquid W from the feeder unit 120 to the collector unit 110. After that, at S702, the pump 142 is activated and starts to feed the liquid W from the collector unit 110 to the feeder unit 120. As a result, the liquid is circulated between the feeder unit 120 and the collector unit 110, so that the cooling process in the collector unit 110 is performed. Then, at S703, the pump 140 is activated and starts to feed the liquid W from the feeder unit 120 to the UFB generator unit 100. Subsequently, at S704, the UFB generator unit 100 is activated and starts to generate UFB. Then, a temperature management process is performed at S705. The details of the process at S705 will be described later.

At the end of the temperature management process, whether or not a UFB generation completion signal is detected is determined at S706. If the signal is not detected (No), the processing shifts to S707, waits for a certain period of time, returns to S705, and iterates the processes at S707, S705, and S706 until the signal is detected. If the UFB generation completion signal is detected (Yes) at S706, the UFB generation processing is ended. Specifically, a three-way valve 170 is switched to take out the UFB-containing liquid through the liquid collection tube 132 to the outside of the apparatus.

Next, with reference to FIG. 7B, the details of the process at S705 in FIG. 7A (temperature management process) will be described.

Upon the start of the temperature management process, at S710, the value of the temperature T3 of the liquid W is obtained from the liquid temperature sensor 302 and the obtained value is stored in the RAM 202. After that, at S711, the value of the temperature T1 of the UFB-containing liquid UW1 is obtained from the temperature sensor 300 and the obtained value is stored in the RAM 202. Thereafter, at S712, the value of the temperature T2 of the UFB-containing liquid UW2 is obtained from the liquid temperature sensor 301 and the obtained value is stored in the RAM 202.

Then, at S713, the control on the cooler unit 150 such as ON/OFF control and a change of the set temperature is performed based on the temperature values of these sensors stored in the RAM 202. Specifically, the cooler unit 150 is controlled so that the conditions T2<T1 and T2<T3+5° C. can be satisfied, and the temperature management process is ended.

As described above, the apparatus is configured such that the liquid can be circulated between the collector unit 110 and the ultra fine bubble generation unit 100 and between the collector unit 110 and the feeder unit 120. Then, the cooler unit 150 provided to the feeder unit 120 is controlled so that the temperature of the liquid in the collector unit 110 can be lower than the temperature of the liquid containing ultra fine bubbles generated in the ultra fine bubble generation unit 100. Accordingly, it is possible to provide an ultra fine bubble production apparatus and production method capable of collecting ultra fine bubbles efficiently.

In the present embodiment, 200 ml of pure water was stored in the feeder unit 120, and the cooler unit 150 was operated to regulate the temperature T3 of the pure water W in the feeder unit 120 at 10° C. Oxygen was introduced through the gas inlet tube 160 to produce supersaturated oxygen water (the concentration of dissolved oxygen: 20 mg/L or more). Then, the pumps 142 and 143 were first operated at 50 mL/min to pour cooling water, and then the UFB generator unit 100 was operated with feeding of the supersaturated oxygen water at 10 mL/min by using the pump 140 until the UFB concentration reached a desired concentration (250 million/mL), while the temperature T1 of the UFB-containing liquid UW1 in the UFB generator unit 100 was regulated within the maximum temperature of 38° C. and the temperature T2 of the UFB-containing liquid UW2 in the collector unit 110 was regulated within the maximum temperature of 19° C. In the above case, the number of circulations used to reach the desired concentration (here, the number of circulations is incremented by one, for example, every time “the total amount of liquid sent by the pump 140 divided by the amount of liquid stored in the feeder unit 120” is equal to 1) was 24.

On the other hand, in the case where the temperature T2 of the UFB-containing liquid UW2 in the collector unit 110 reached the maximum temperature of 45° C. without operation of the pumps 142 and 143, the number of circulations used to reach the desired concentration was 38.

Each of the number concentrations was measured 24 hours after the generation of the UFB-containing liquid by using the measurement instrument (model type SALD (registered trademark)-7500 nano) manufactured by Shimadzu Corporation.

From these results, the present embodiment can be said to produce a certain effect of improving the collection efficiency of highly-concentrated ultra fine bubbles.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Applications No. 2023-039740 filed Mar. 14, 2023 and No. 2023-209478 filed Dec. 12, 2023, which are hereby incorporated by reference wherein in their entirety.

What is claimed is:

1. An ultra fine bubble production apparatus comprising:
an ultra fine bubble generator configured to generate ultra fine bubbles;
a collector configured to collect a liquid containing the ultra fine bubbles generated in the ultra fine bubble generator;
a first cooler capable of cooling a liquid in the collector; and
a controller configured to control the first cooler, wherein
the controller controls the first cooler so that a temperature of the liquid in the collector is lower than a temperature of the liquid containing the ultra fine bubbles generated in the ultra fine bubble generator.

2. The ultra fine bubble production apparatus according to claim 1, further comprising:
a first thermometer capable of obtaining the temperature of the liquid in the ultra fine bubble generator; and
a second thermometer capable of obtaining the temperature of the liquid in the collector, wherein
the controller controls the first cooler based on the temperature obtained by the first thermometer and the temperature obtained by the second thermometer.

3. The ultra fine bubble production apparatus according to claim 2, further comprising:
a feeder configured to feed a liquid to the ultra fine bubble generator; and
a third thermometer capable of obtaining a temperature of the liquid in the feeder, wherein
the controller controls the first cooler based on the temperature obtained by the first thermometer, the temperature obtained by the second thermometer, and the temperature obtained by the third thermometer.

4. The ultra fine bubble production apparatus according to claim 3, wherein
the feeder also functions as the collector, and
the third thermometer also functions as the second thermometer.

5. The ultra fine bubble production apparatus according to claim 1, wherein the first cooler cools the liquid by cooling the collector.

6. The ultra fine bubble production apparatus according to claim 1, wherein the first cooler comes into contact with the liquid collected by the collector, thereby cooling the liquid.

7. The ultra fine bubble production apparatus according to claim 3, further comprising a second cooler capable of cooling the liquid in the feeder.

8. The ultra fine bubble production apparatus according to claim 7, wherein the second cooler cools the liquid by cooling the feeder.

9. The ultra fine bubble production apparatus according to claim 7, wherein the second cooler comes into contact with the liquid to be fed by the feeder, thereby cooling the liquid.

10. The ultra fine bubble production apparatus according to claim 3, wherein the controller controls the first cooler so that the temperature obtained by the second thermometer is lower than a temperature higher by 5°° C. than the temperature obtained by the third thermometer.

11. The ultra fine bubble production apparatus according to claim 1, further comprising a solubility detector configured to detect a gas solubility of the liquid collected by the collector, wherein
based on each gas solubility which depends on a gas type and is detected by the solubility detector, the controller controls the first cooler so that a change in the gas solubility of the liquid collected by the collector is kept within 50 mg/L.

12. The ultra fine bubble production apparatus according to claim 1, further comprising a circulation channel configured to circulate the liquid in a manner capable of feeding the liquid collected by the collector to the ultra fine bubble generator.

13. The ultra fine bubble production apparatus according to claim 1, further comprising:
a feeder configured to feed a liquid to the ultra fine bubble generator;
a first circulation channel configured to circulate the liquid in a manner capable of feeding the liquid collected by the collector to the ultra fine bubble generator; and
a second circulation channel configured to circulate the liquid between the collector and the feeder, wherein
the first cooler cools the liquid in the collector by cooling the liquid in the feeder.

14. The ultra fine bubble production apparatus according to claim 1, wherein the ultra fine bubble generator generates the ultra fine bubbles by heating a heating element and thereby causing film boiling at an interface between the heating element and the liquid.

15. An ultra fine bubble production method comprising:
an ultra fine bubble generation step of generating ultra fine bubbles;
a collection step of collecting a liquid containing the ultra fine bubbles generated in the ultra fine bubble generation step;
a first cooling step of cooling the liquid collected in the collection step with a first cooler; and
a control step of controlling the first cooler, wherein
the control step includes controlling the first cooler so that a temperature of the liquid collected in the collection step is lower than a temperature of the liquid containing the ultra fine bubbles generated in the ultra fine bubble generation step.
